(19) United States
(12) Patent Application Publication
(10) Pub. No.: US 2004/0026313 A1
(43) Pub. Date: Feb. 12, 2004

(54) Multi-micron, multi-zoned mesh, method of making and use thereof

(76) Inventor: Todd Kenneth Arlon Fischer, Oxford, MD (US)

Correspondence Address: SMITH, GAMBRELL & RUSSELL, LLP, ATTORNEYS AT LAW, SUITE 800, 1850 M STREET, N.W., WASHINGTON, DC, 20036, US

(21) Appl. No.: 10/215,261

(22) Filed: Aug. 9, 2002

(51) Int. Cl. B01D 29/21

(52) U.S. Cl. 210/484; 210/487; 210/489; 210/499; 210/497.1; 29/896.62

(57) ABSTRACT

A multi-micron, multi-zoned woven metal wire mesh for the production of sand control screens. The multi-zone, dual micron layer is spirally wound on top of a perforated metal pipe. Second and third metal mesh filtration layers are spirally wound on top of the three-zone, dual micron layer, respectively. A perforated metal shroud is placed on top of the entire assembly to protect from the surrounding environment and acts as a protective cover.

### BACKGROUND OF THE INVENTION

The present invention relates to a multi-micron, multi-zoned woven wire mesh used for making pipes employed in petroleum and hydrocarbon production.

The oil and gas industries employ specialty pipes for oil and gas wells. One type of specialty pipe used down-hole, is called a “sand control screen”. These screens prevent sand and debris from passing from the outside of the pipe to the inside of the pipe while allowing the petroleum products to pass from the outside of the pipe to the inside of the pipe.

The construction of sand control screens usually incorporates a perforated base pipe which is covered by one or more layers of metal wire mesh, each layer having its own specific filtration rating throughout its entirety, followed by an external perforated protective shroud. Since the mesh layers used in this construction are from generally rectangular pieces, which are wrapped around the base pipe in various patterns and in successive layers, a seam necessarily exists at each mesh layer.

The seam created at and by each mesh layer must be sealed for proper performance of the sand control screen. This is especially true for the filtration mesh layer. The seals must be created in such a way so that the hydrocarbons traveling from the external side of the sand control screen to the internal side of the sand control screen are not afforded the opportunity to “bypass” or “short circuit” the filtering layer and thus carry sand and debris through the sand control screen to the inner diameter.

The seals must be created in such a way as to ensure their longevity once placed down-hole which is a corrosive and erosive environment. These seals must be created in such a way as to reduce excessive thickness at the seal so that the wall thickness can be minimized for a given outer diameter of a sand control screen.

Sand control screens which incorporate mesh screens as their filtering media are fabricated in various constructions. Two constructions that can be used are those that have longitudinal seams along their mesh layers and those that have spiral seams along their mesh layers.

Sand Screens With Longitudinal Seams

In those sand control screens with longitudinal seams in their mesh layers, individual rectangular pieces of mesh are wrapped around a base pipe in successive layers creating a single longitudinal seam at each mesh layer. More than one layer of mesh may be positioned around the base pipe as part of the construction.

In the longitudinal seam construction, the length of the rectangular pieces of mesh is designed to match the approximate length of the sand control screen's base pipe, while the width of the rectangular mesh piece is designed to be approximately equal to that of the circumference of the sand control screen's base pipe. Each mesh layer is selected based on its filtration properties and each mesh layer has the same filtration properties throughout the entirety of that piece. In this longitudinal seam construction, a seam exists for each layer of mesh incorporated into the design.

The seals established at the longitudinal seams created by this construction can have various forms, i.e., as follows:

1. butt seal—the longitudinal seam is formed by the edges of the mesh butting up to each other.

2. welded seal—a seal is created by welding the edges of the mesh together at the longitudinal seam.

3. overlapping seal—a seal is created by overlapping the edges of the mesh.

FIGS. 1a), b), and c) show a three-mesh, longitudinal construction sand control screen with the various seals incorporated at the mesh seams.

Sand Screens With Spiral Seams

In those sand control screens with spiral seams in their mesh layers, individual, long rectangular pieces of mesh are wrapped around a base pipe in successive layers in such a way as to create a spiral seam at each mesh layer. More than one layer of mesh may be positioned around the base pipe as part of the construction.

In this spiral seam construction, the length and width of the rectangular pieces of mesh can be selected by those skilled in the art of spiral tube making. In general terms, the width of the long rectangular strip is approximately equal to the diameter of the sand control screen, while the length of the rectangular strip is approximately twice to three times as long as the sand control screen's base pipe. The aforementioned are only approximations and are included to give one the ability to distinguish the relative size of the rectangular pieces of mesh used in the longitudinal construction versus the rectangular pieces used in the spiral construction.

Each mesh layer is selected based on its filtration properties and each mesh layer has the same filtration properties throughout the entirety of that piece. In this spiral seam construction, a seam exists for each layer of mesh incorporated into the design. The seals established at the spiral seams created by this construction can have various forms, as mentioned below:

1. butt seal—the seal is formed by the edges of the mesh butting up to each other.

2. welded seal—a seal is created by welding the edges of the mesh together at the longitudinal seam.

3. overlapping seal—a seal is created by overlapping the edges of the mesh.

FIGS. 2a), b), and c) show a three-mesh, spiral construction sand control screen with the various seals incorporated at the mesh seams.

The number of mesh layers used as part of the construction of a sand control screen usually number two (2) or more. Most sand control screens have a coarse layer of mesh positioned directly on the base pipe, with a filtration layer located on top of the coarse layer. In some sand control screens, a coarse layer is placed on the base pipe, a filtration layer is placed on the coarse layer and a pre-filtration layer is further placed on the filtration layer. The second layer is usually referred to as the filtration layer and the third layer is usually referred to as the pre-filtration layer. Not all sand control screen constructions have a support/drainage layer, and not all sand control screen constructions have a pre-filtration layer, however, most sand control screen constructions have a filtration layer with at least one other layer, be it a support/drainage layer or a pre-filtration layer.

Whether the basic construction is that of a longitudinal seamed sand control screen or a spiral seamed sand control screen, or whether the sand control screen incorporates the use of two or more layers of mesh, the ability to create an effective and long lasting seal at the seams of the mesh layers remains a focus for all those working in the design and manufacture of sand control screens. This applies equally to non-expandable sand control screens and the recently developed expandable sand control screens.

It is especially important to create a full and long lasting seal at the filtering layer seam. A poor, inconsistent or non-existent seal at the filtering layer seam will cause a condition often referred to as “filtration bypass” or “filtration short-circuit”. “Filtration bypass” or “filtration short-circuit” refers to a condition whereby the fluid that is to be filtered as it moves from the outside of the sand control screen to the inside of the sand control screen, is able to move across the filtering layer through a hole, an imperfection, or an un-sealed seam point without being challenged by the filter mesh. When a pathway exists for the fluid to move through the plane of the filter mesh without being challenged by that filter cloth, the fluid is said to be bypassing the filter, or is said to be short circuiting the filter, thus the common use of the words “filtration bypass” or “filtration short-circuit.” A sand control screen, the filtration layer of which is bypassed, will carry sand and debris into the center of the sand control screen where it may cause damage or inefficiencies to the hydrocarbon production process.

Each of the three seam sealing mechanisms noted above (butt seal, welded seal, and overlapping seal) has benefits and detriments to the performance of the sand control screen:

a) Seams that are sealed by butting the edges of the mesh together can leave small pathways that would allow the fluid to bypass the filtering layer;

b) Seams that are sealed by welding often fail prematurely in the corrosive and erosive down-hole environment due to the metallurgical and mechanical changes that occur at the weldment. Seams that are sealed by welding can also cause the sand control screen's wall thickness to be greater than would need to be if no weld were present; and

c) Seams that are sealed by overlapping the mesh layers cause the sand control screen's wall thickness to be greater than would need be if no mesh overlap were present. Although the overlapping seal is more positive than the butt style seal, it is not as positive as the welded style seal.

It can be seen that none of the three types of seam seal types listed above fully satisfy the need to ensure; a) no bypass at the seal, b) longevity of the seal in a corrosive and/or erosive environment, and c) the minimum wall thickness for a given outer diameter sand control screen. Both the longitudinal seam and the spiral seam constructions, as well as the three seam seal styles discussed above, and the use of one or more layers of mesh, are used widely in both expandable and non-expandable sand control screens.

Some engaged in the production of non-expandable sand control screens which have excluded the weld seal practice have created perforation patterns in the base pipes that prevent the alignment of a seam with a base pipe perforation hole. This has helped to reduce the probability and possibility of bypass considerably, but has not eliminated it fully.

Those engaged in the production of expandable sand control screens that have not incorporated the welded seal practice have moved away from using base pipes with perforation patterns that prevent the alignment of a seam with a base pipe perforation hole. They have moved away from this design concept primarily because the base pipe incorporated in the sand control screen does not expand uniformly and/or consistently when the perforation patterns that would prevent the alignment of a seam with a perforation hole are incorporated.

Manufacturers that are moving away from the use of welded seals and moving away from the use of special perforation patterns designed to prevent the alignment of a seam with a base pipe perforation hole are increasing the possibility and probability that the filtration layer of the sand control screen can be bypassed. With current designs and current technology, the various design objectives, need to:

a) eliminate the possibility of filtration bypass,

b) ensure longevity of the seal in a corrosive and erosive environment,

c) minimize wall thickness for a given outer diameter, and

d) expand the sand control screen uniformly.

These objectives can be and in most cases are in competition with each other.

This can be seen by reviewing three current and typical sand control screen designs available in the market, which are not of the current invention.

Consider a current expandable sand control screen design which incorporates a spiral construction with butt seal seams. With this approach, this sand control screen can expand because the hole pattern on the center pipe (core) does not form a spiral landing (spiral zone without holes). (FIG. 3). A pipe with holes is spirally wrapped with a first drainage layer of metal mesh. A second layer (filtration) of metal mesh is spirally wound on top of the drainage layer so that the edges of the second layer lie on top of the center of the first layer. A third layer (pre-filtration) of metal mesh is then spirally wound on top of the second layer so that the edges of the third layer lie on top of the center of the second layer. This positions the seam in the pre-filtration layer above the center of the filtration layer, and positions the seam in the filtration layer above the center of the drainage layer. A protective shroud (perforated pipe) is placed over the entire aforementioned assembly. However, in this design, a potential flow bypass path is formed due to the alignment of the filtration layer seam with the perforation holes in the base pipe.

In another approach, the design starts with a metal pipe with a plurality of drilled holes in a spiral landing hole pattern. (FIG. 4). The drainage mesh layer is spirally wound on top of the metal pipe in such a way as to align the center of the drainage mesh with the section of the center pipe which has no holes (spiral landing). A filtration mesh layer is spirally wound on top of the drainage mesh layer in such a fashion as to align the edges of the filtration mesh with the center of the drainage mesh, and thus, with the section of the center pipe with the spiral landing. A third layer (pre-filtration layer) of mesh is spirally wound on top of the second layer so the edges of the third layer lie on top of the center of the second layer. This structure positions the seam in the pre-filtration layer above the center of the filtration layer, and positions the seam in the filtration layer above the center of the drainage layer. Again, a protective shroud, is placed over the entire assembly. This design, however, though it has significantly reduced the possibility of filtration bypass, cannot expand fully because the specially designed hole pattern on the base pipe forms a spiral landing which frustrates the base pipe's ability to expand fully and uniformly. The result again is a sub-optimal sand control screen.

In yet another approach, the design uses a single micron mesh weave as the drainage layer which is the same micron rating as the filtration mesh layer. (FIG. 5). The design structure employs a metal base pipe with uniformly spaced holes along its length. A first layer of drainage mesh is spirally wound around the metal pipe. A second layer (filtration layer) of mesh is spirally wound on top of the first layer so that the edges of the second layer lie on top of the center of the first layer. A third layer (pre-filtration layer) of mesh is spirally wound on top of the second layer so that the edges of the third layer lie on top of the center of the second layer. This positions the seam in the pre-filtration layer above the center of the filtration layer, and positions the seam in the filtration layer above the center of the drainage layer (which in this construction is another filtration layer). The design is completed with a protective shroud (perforated pipe) placed over the entire assembly. This design can expand because the hole pattern on the center pipe (core) does not form a spiral landing and, there is no bypass path in the design. However, the design is inferior because of the increased pressure drop, decreased performance, and higher expense.

Accordingly, it is felt there is a need in the art for a design which solves the physical contradictions faced by the prior art;

can expand fully and uniformly because the holes in the center pipe do not form a specially engineered pattern designed to eliminate the intersection of a mesh seam with a hole, and

no incorporation of a bypass path, and

the design is cost efficient.

This invention allows manufacturers of longitudinal style sand control screens and/or spiral style sand control screens which incorporate one or more layers of mesh in their construction to move away from the welded seal and/or to move away from the use of special perforation patterns in the base pipe while simultaneously reducing the possibility and probability of filtration bypass, minimizing wall thickness, and/or allowing for uniform expansion of the base pipe.

### SUMMARY OF THE INVENTION

In overcoming some of the drawbacks of prior systems, one feature of the present invention resides in a multi-micron, multi-zoned single piece/layer, woven metal mesh that can be employed in sand control screens.

The woven metal mesh of the present invention is a specialty mesh which has multiple zones of differing filtration ratings within a single piece/layer of the woven mesh. This specialty mesh can be used in various constructions and will provide some or all of the following benefits depending on the embodiment.

For Longitudinal and Spiral Style in both expandable and non-expandable sand control screens, this specialty mesh will allow one to accomplish one or more of the following:

a) retain the number of mesh layers in the construction but reduce the number of mesh seams in the construction to a single seam;

b) provide a redundant filtration layer below or above the seam seal of the filtration mesh layer while still maintaining the gross properties of the drainage layer and/or pre-filtration layer, and without increasing the wall thickness of the sand control screen;

c) eliminate the use of base pipes whose perforation patterns are engineered/designed to avoid the alignment of perforation hole and mesh seam;

d) provide an overlapping seam construction without increasing the wall thickness beyond the same wall thickness provided by a butt seam construction, and

e) reduce the overall cost of manufacturing sand control screens.

A woven metal wire mesh consisting of a plurality of parallel warp wire filaments intersected by a plurality of parallel chute wire filaments, and when woven together on a loom make a woven wire screen or woven wire mesh. A feature of the invention is that the number of wires (wire count), the spacing of the wires and wire diameters of each of the warp wire filaments are varied to produce the desired profile of the woven wire cloth with different filtration characteristics across the width of the mesh cloth.

Thus, the multi-micron multi-zone woven wire mesh of the present invention has more than one zone of unique filtration properties throughout and across the entirety of the mesh and is established by selecting the appropriate warp wire count and/or warp wire diameter for each specific region within the mesh. With a given single layer and single length of multi-micron multi-zone woven wire mesh, it is possible to create a mesh with regions or zones, each zone having its own warp wire count, its own warp wire diameters, and its own weave pattern so that the filtration properties within that zone are unique to that zone.

The mesh design of the present invention is typically rectangular in shape with a very long main axis, e.g. 60 feet and a relatively small minor axis, e.g. 6 inches. A three-zone, dual micron mesh layer structure is formed in this layer by a variety of techniques. Thus, for example, the number of warp wires in the two lateral areas of, say, two inches can be less (for example, one half) the number of warp wires in the central portion of the mesh layer. Alternatively, or in addition, the diameter of wires in one zone can be different from the diameter of wires in an adjacent zone. The first metal mesh layer, for example, can include a single layer mesh specialty weave with a mesh size having a fine micron rating in a center region. Lateral regions, with more coarse mesh size micron rating, border the center region on either side. The design prevents the increased pressure drop that would exist if the layer were a mesh of a single fine micron weave design. A single layer, three-zone woven metal mesh can serve as the first layer to be wrapped around the core. A second layer of metal mesh of uniform filtration characteristics is spirally wound on top of the first metal mesh layer, aligning the lateral edges of the second metal mesh layer to the center midline area of the first metal mesh layer in the center region. A third metal mesh layer of uniform filtration characteristics is spirally wound on top of the second metal mesh layer, aligning the edges of the third metal mesh layer with the center midline area of the second metal mesh layer. By aligning the lateral edges of the respective second and third metal mesh layers to the midline areas of the preceding mesh layer, one ensures filtration in the seam areas, where the spirally wound lateral edges of the respective mesh layer lie next to each other after the winding process. The holes in the center pipe (core) do not form a spiral landing and thus allow the sand control screen to expand fully and uniformly. There is no bypass path in this design, therefore, a more efficient filtration process is achieved.

It is a further feature of the present invention that the fine weave zone on the dual micron, three-zone mesh does not need to be located centrally. The multi-weave layer can be a dual micron, dual weave layer. Thus, the location of the fine micron zone can be located on one side of the layer, so that, for example, in a six inch wide strip, the fine micron zone can be 1.5 inches wide located adjacent to a 4.5 inch wide coarse zone.

### BRIEF DESCRIPTION OF THE DRAWINGS

The various advantages of the present invention will become apparent to one skilled in the art by reading the following specification and subjoining claims and by referencing the following drawings in which:

FIG. 1(a) illustrates a sand control screen not of the present invention—longitudinal style—butt seal;

FIG. 1(b) illustrates a sand control screen not of the present invention—longitudinal style—welded seal;

FIG. 1(c) illustrates a sand control screen not of the present invention—longitudinal style—overlap seal;

FIG. 2(a) illustrates a sand control screen not of the present invention—spiral style—butt seal;

FIG. 2(b) illustrates a sand control screen not of the present invention—spiral style—weld seal;

FIG. 2(c) illustrates a sand control screen not of the present invention—spiral style—overlap seal;

FIG. 3 illustrates a prior design of a spiral wound screen system;

FIG. 4 is a prior design of a pipe sand control screen with a center pipe forming a spiral landing in an attempt to eliminate/reduce a potential bypass path;

FIG. 5 is a prior design of a pipe sand control screen with a center pipe that does not form a spiral landing and which significantly reduces the possibility of a bypass path;

FIG. 6 is a metal pipe (core) with holes that can be used as the core in the present invention;

FIG. 7a is a drawing of a three-zone, dual micron layer embodiment of the claimed invention;

FIG. 7b is a drawing of the three-zone, dual micron layer of FIG. 7a wound around a core;

FIG. 8 is a drawing depicting a single mesh weave embodiment of the claimed invention;

FIG. 9a is a drawing of a pipe sand control system including a filtration layer on top of the three-zone, dual micron layer embodiment of the claimed invention;

FIGS. 9b and 9c are drawings of the first and second layer, respectively applied to the core in FIG. 9a;

FIG. 10a is a drawing of a pre-filtration layer on top of the filtration layer in that embodiment of the claimed invention;

FIG. 10b is a drawing of the composite of layers applied as shown in FIG. 10a; and

FIG. 11 is a drawing of a complete assembly of a sand control screen according to the invention.

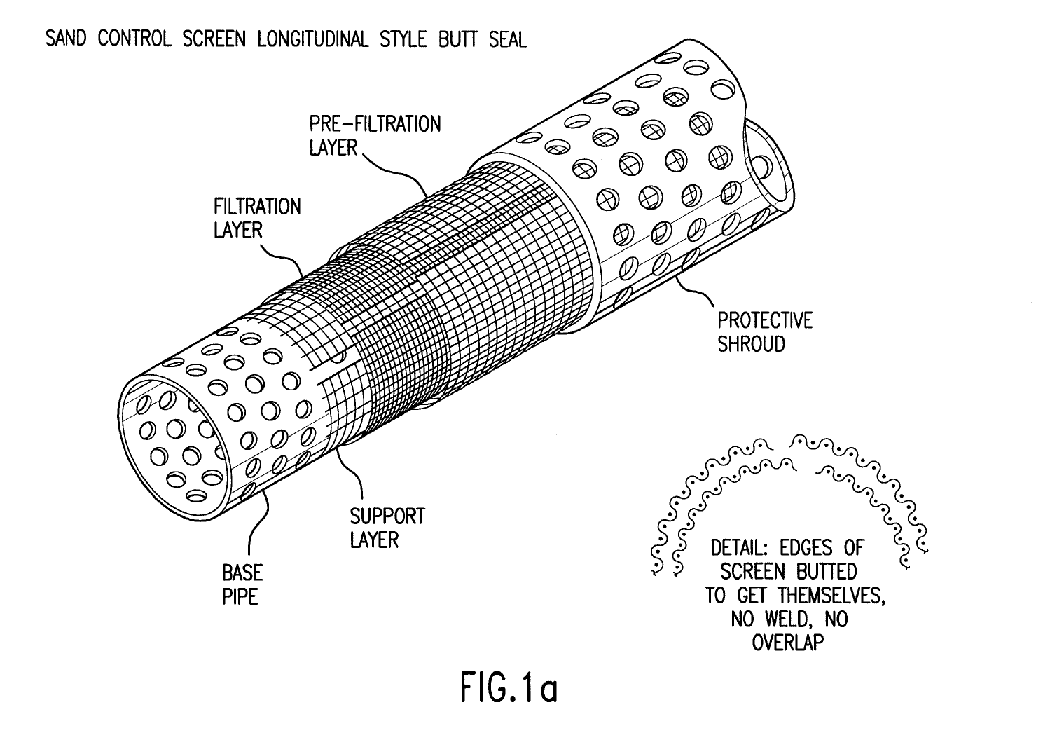

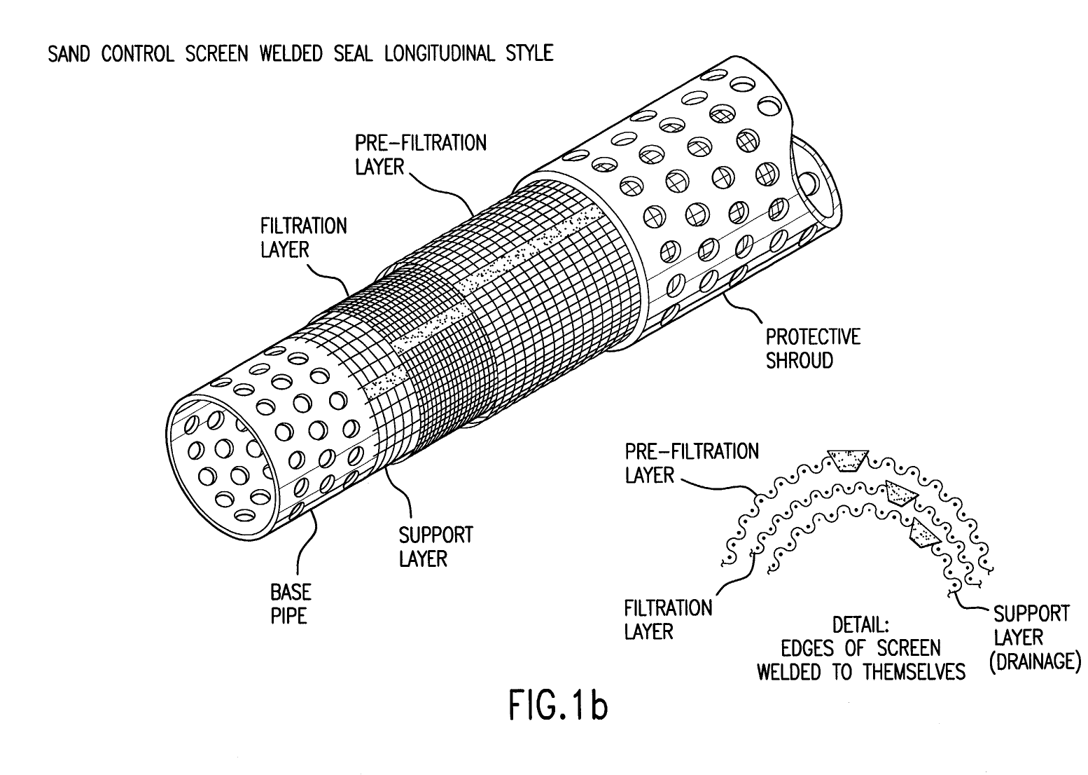

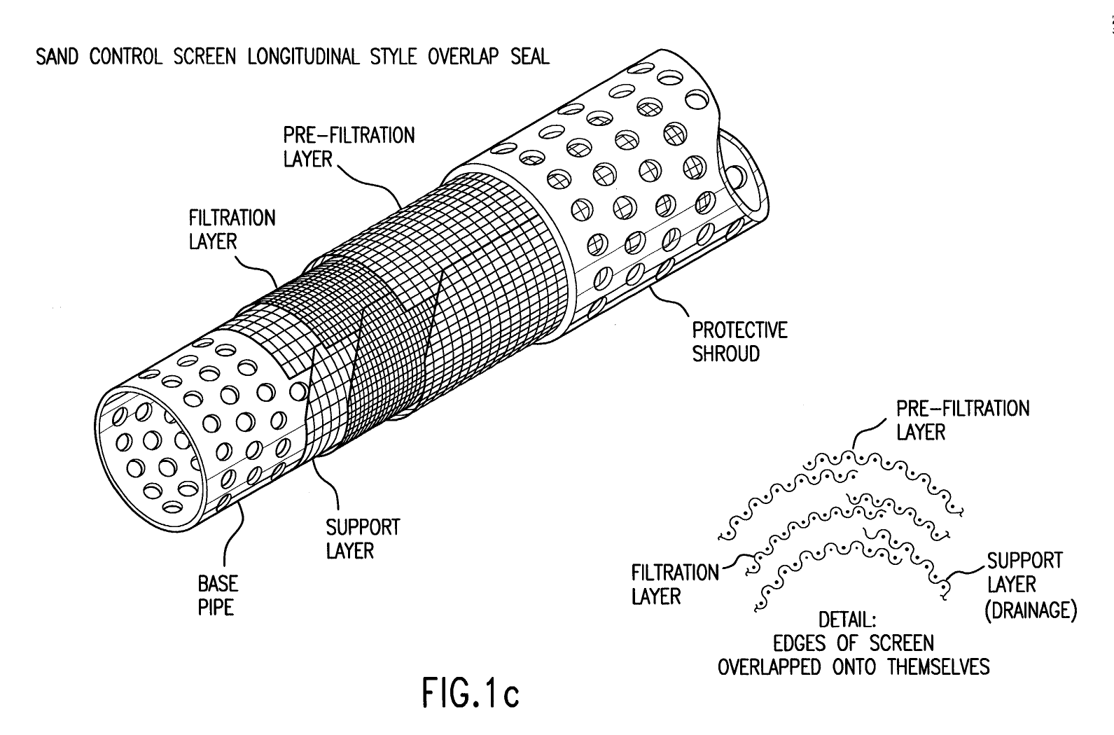

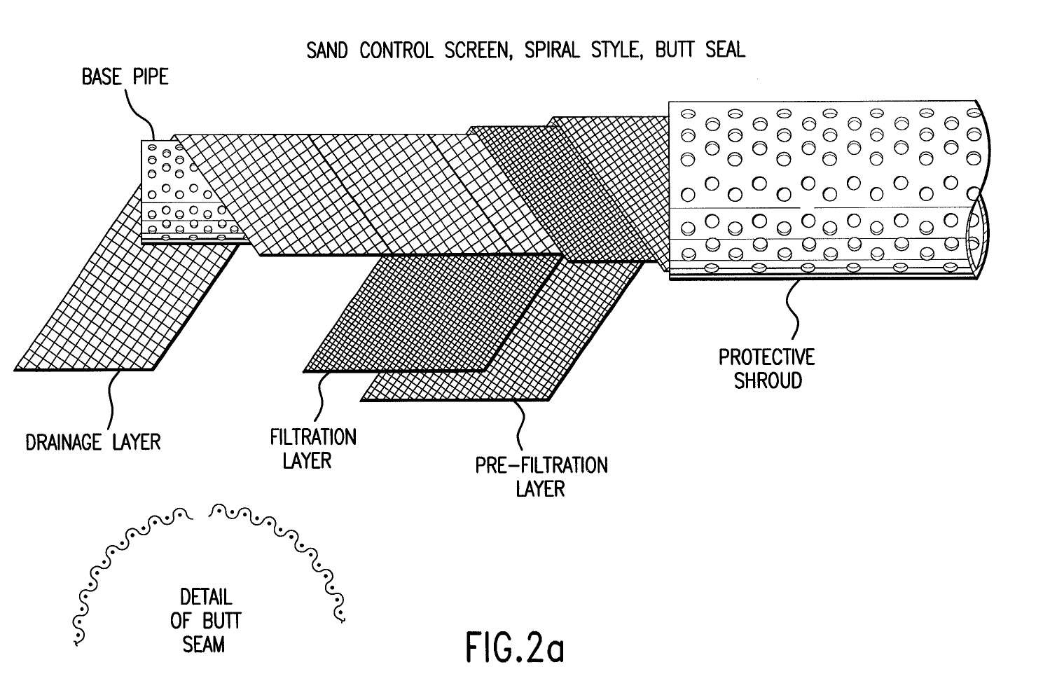

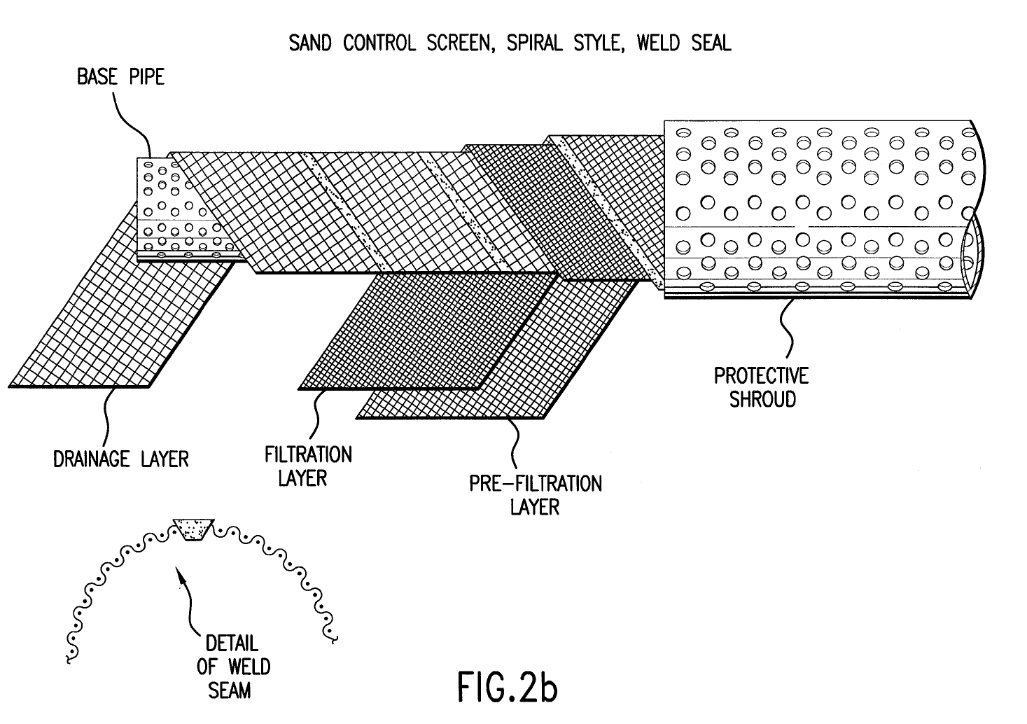

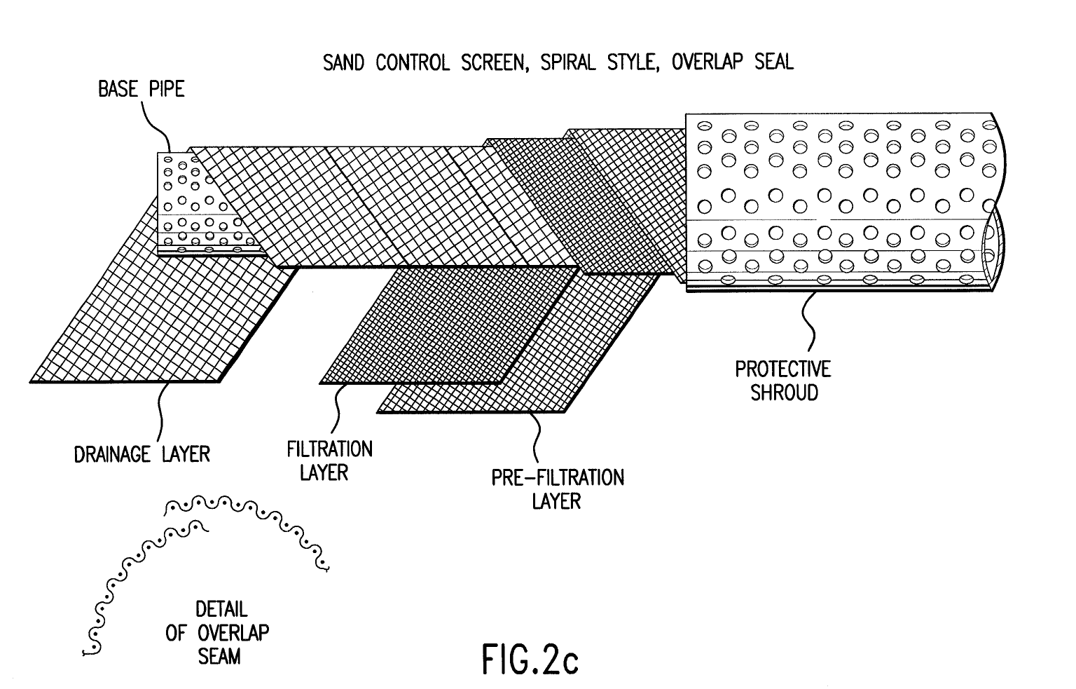

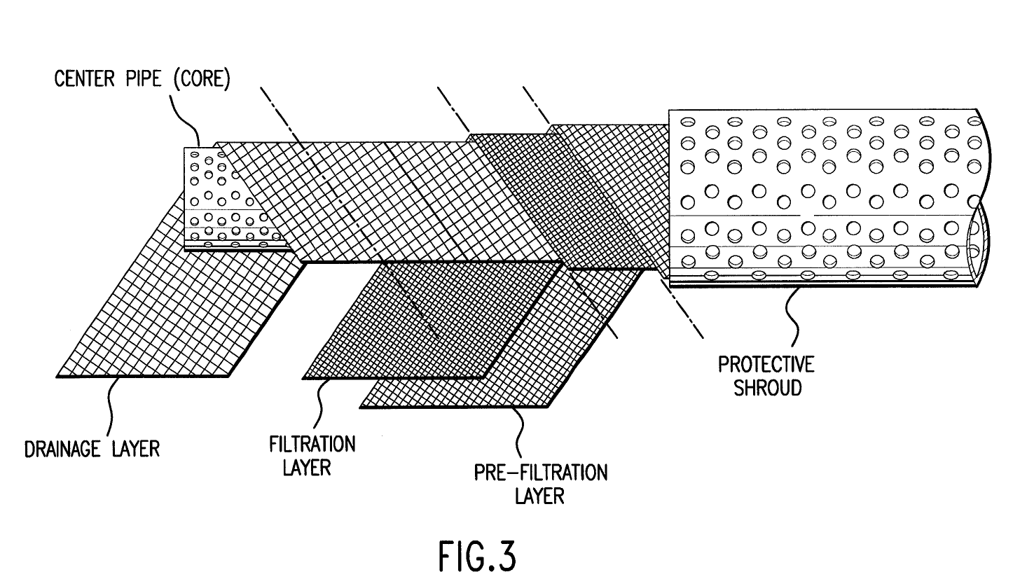

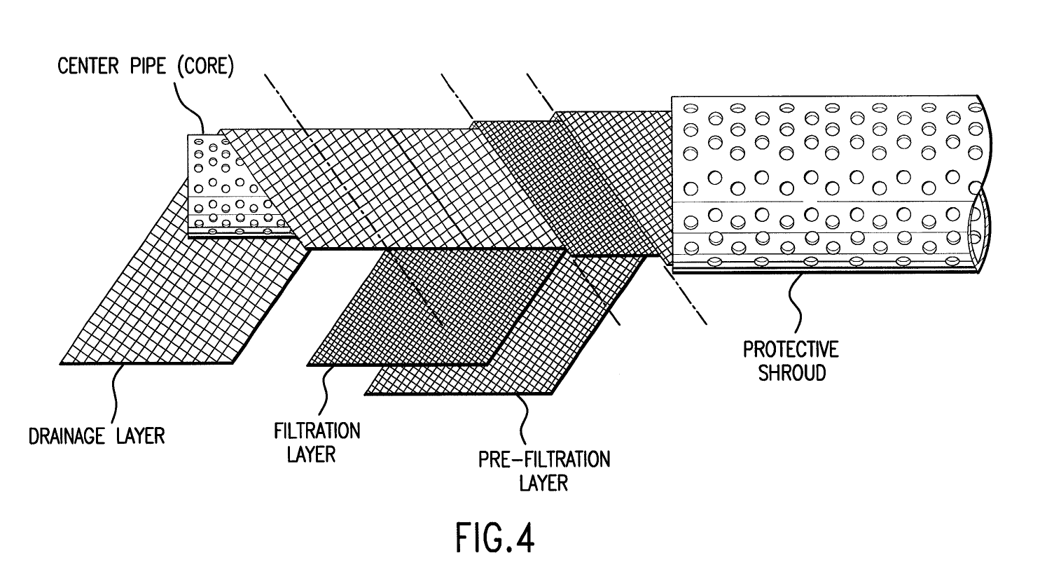

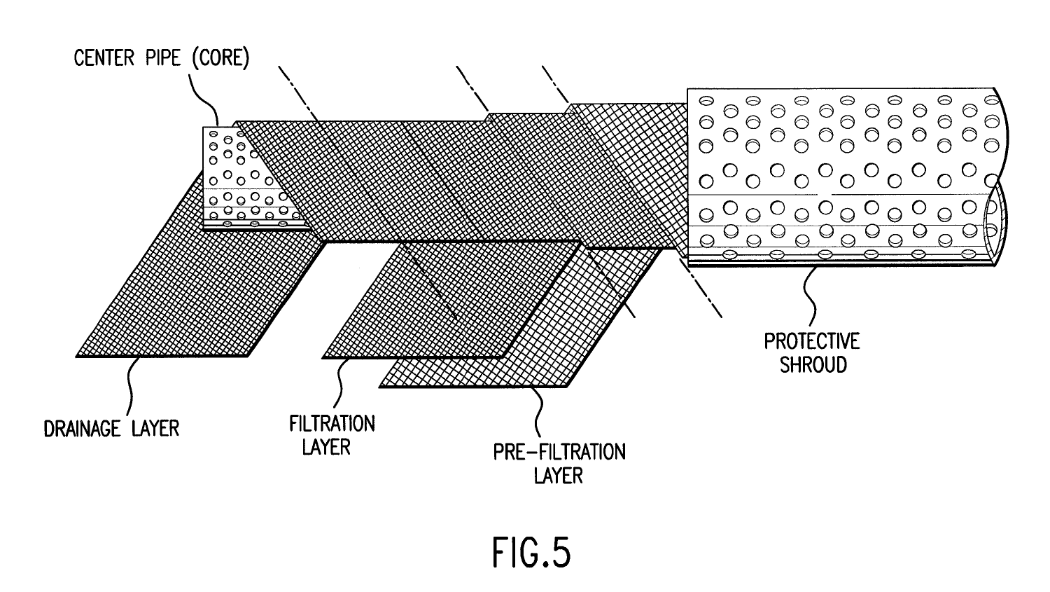

### DETAILED DESCRIPTION OF THE INVENTION

The woven wire mesh fabric of the present invention includes a plurality of parallel and spaced warp wire filaments that are crossed perpendicular to a plurality of parallel and spaced chute wire filaments. The plurality of warp wire filaments are interwoven with the plurality of chute wire filaments and form a mesh cloth. The plurality of parallel warp wire filaments is said to be the warp wire family and the plurality of parallel chute wire filaments is said to be the chute wire family.

In normal wire weaving operations, both the spacing between warp wire filaments and the diameter of the warp wire filaments is constant throughout the entire warp wire family. The same is true for both the spacing and the wire diameter of the chute wire family. The warp wire count (spacing) and/or warp wire diameter of the warp wire family may be different from the chute wire diameters and/or the chute wire count (spacing), but in all conventional woven wire cloths, both the wire count (spacing) and wire diameters are all the same within and throughout each of the respective wire families.

In the multi-micron, multi-zone invention, the wire count (spacing) and/or the wire diameters within the warp wire family is made to be different at different regions within that family so as to cause the resultant mesh cloth to have unique and specifically designed regions with unique and specific filtration properties.

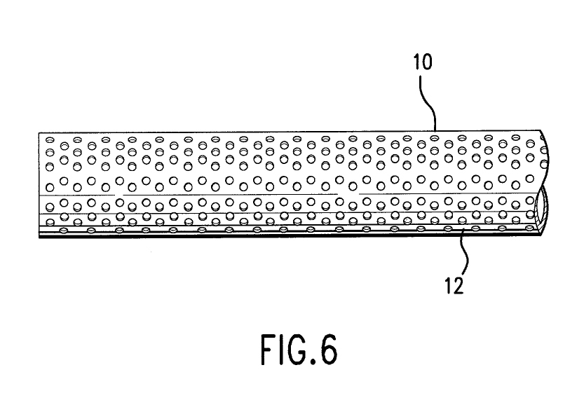

In an embodiment of the presently disclosed invention, a metal pipe 10 of predetermined length has a plurality of holes 12 located on its outer circumference, and extending along its length (FIG. 6). The hole pattern does not have a spiral landing (spiral zone without holes) or any other specially designed pattern incorporated to avoid the alignment of a mesh seam and a perforation hole.

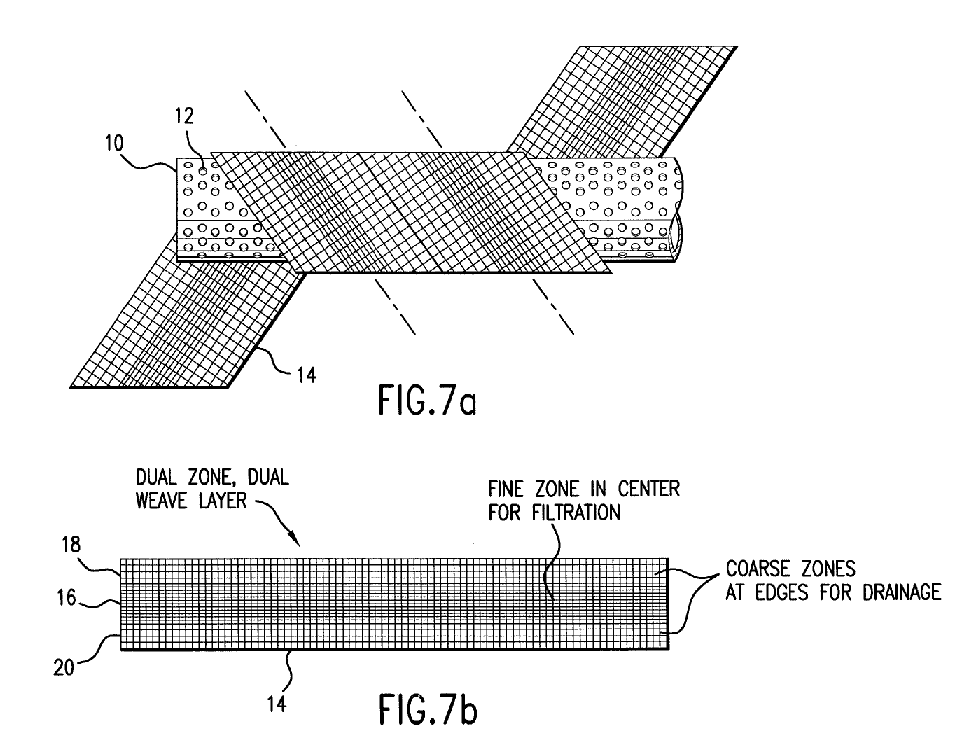

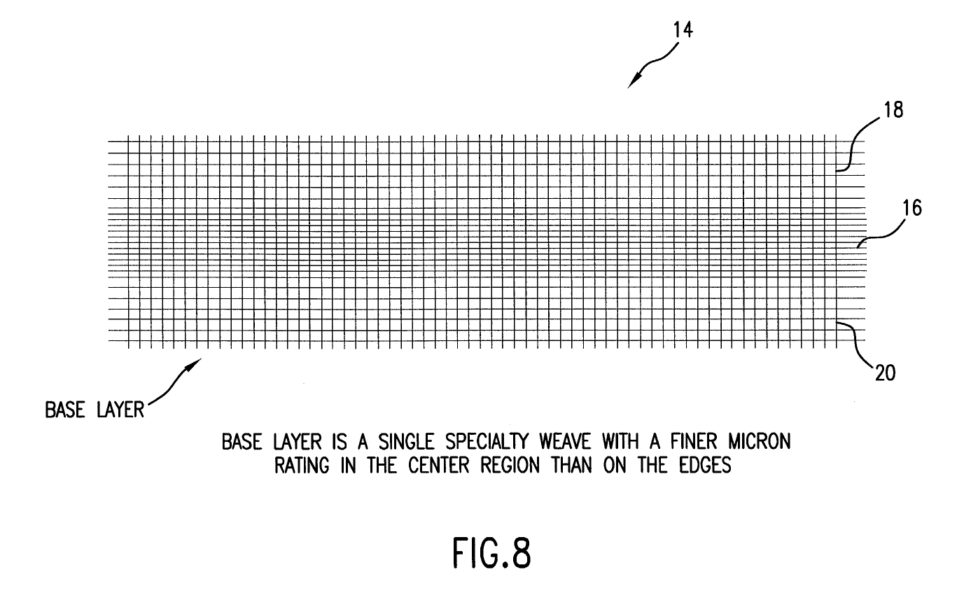

FIG. 7a shows a three-zone, dual micron first metal mesh layer 14 according to the invention. The first metal mesh layer 14 is a single mesh specialty weave having a mesh size with a fine micron rating in a center region 16. (See also FIG. 8). A mesh with a more coarse micron mesh size rating first and second lateral regions 18, 20 are located on either side of the center region 16. The fine micron rating mesh zone, the center region 16, is employed for filtration, whereas, the lateral more coarse micron rating mesh zones, lateral regions 18, 20 at the edges, are for drainage. As shown, the center region 16 and the lateral regions 18, and 20 are each approximately one-third of the width of the first metal mesh layer. However, their relative dimensions can vary. The width of the center or finer mesh size is that which is sufficient to be an effective, filtering layer positioned below the seam created by the second mesh layer (filtering layer) and which prevents filtration bypass from occurring. Thus, the position and mesh size of the center portion of the layer 14 is such as to avoid fluid bypass from occurring.

FIG. 7b shows the woven metal wire mesh layer wound around a core pipe 10.

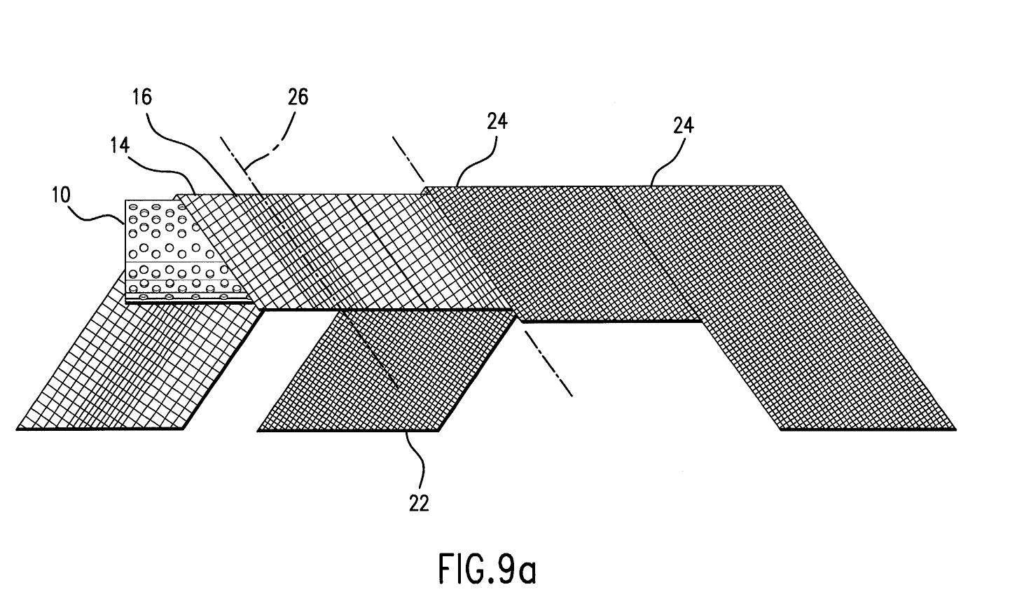

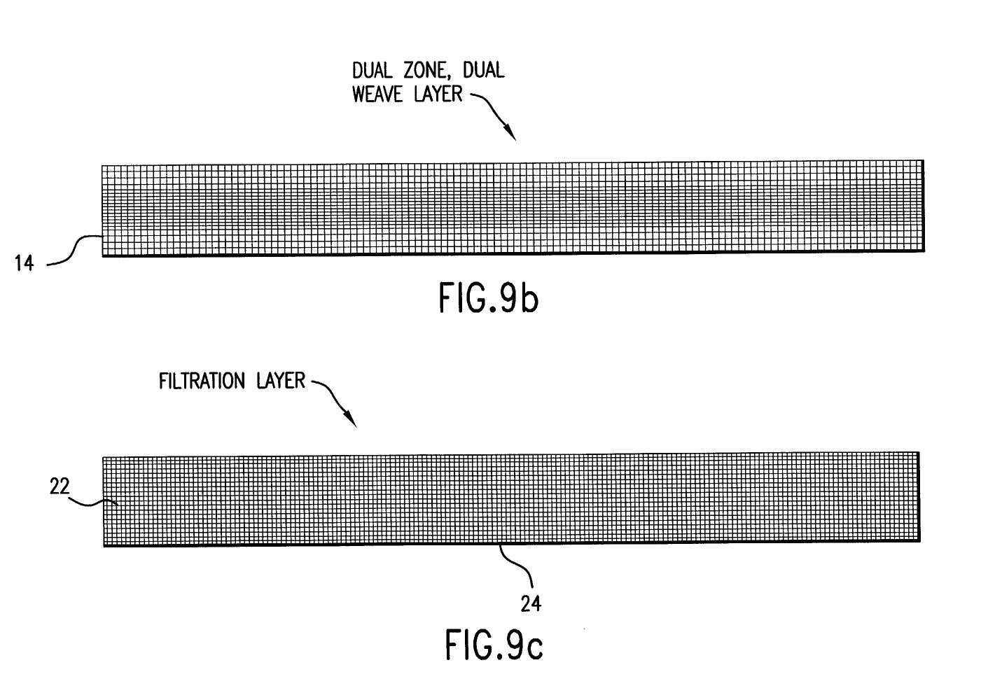

A second metal mesh layer 22, (see FIG. 9c) with a micron mesh rating that can be equal to, less or greater in mesh size than the center zone of the first metal mesh layer 14, (see FIG. 9b) is spirally wound on top of the first metal mesh layer 14. The edges 24 of the second metal mesh layer 22 are aligned to lie on top of the first center midline 26 of the first metal mesh layer 14 in the center region 16. This positions the abutting edges of the second metal mesh layer 22 above the filtration zone (center region 16) of the first metal mesh layer 14. (See FIG. 9a).

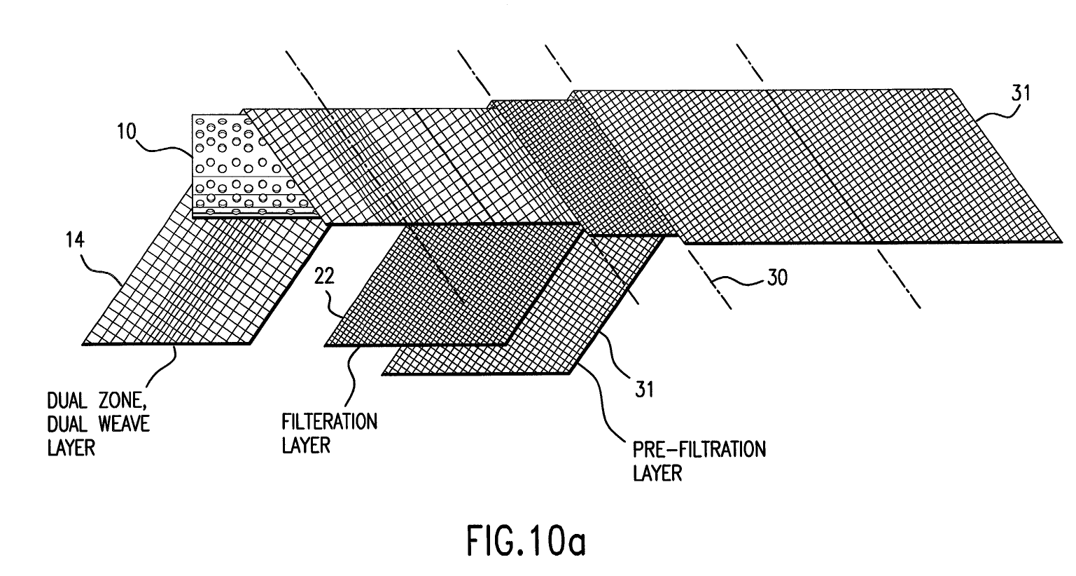

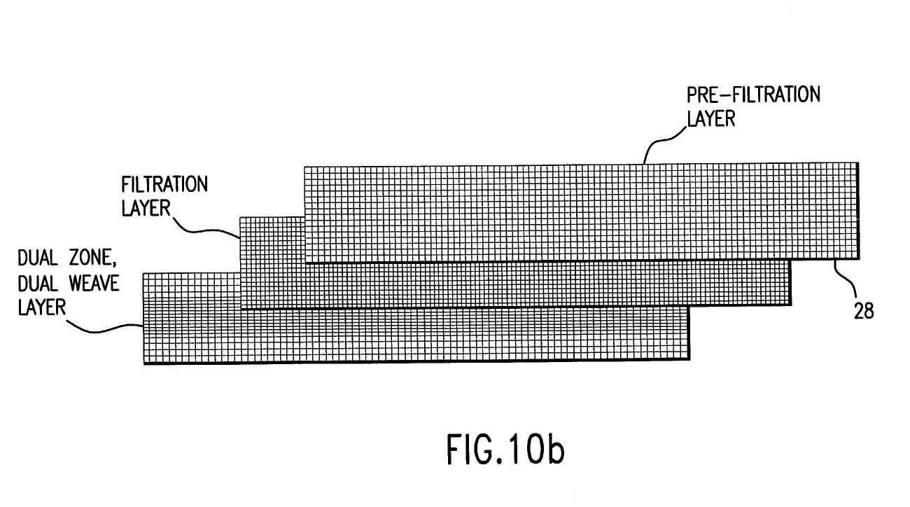

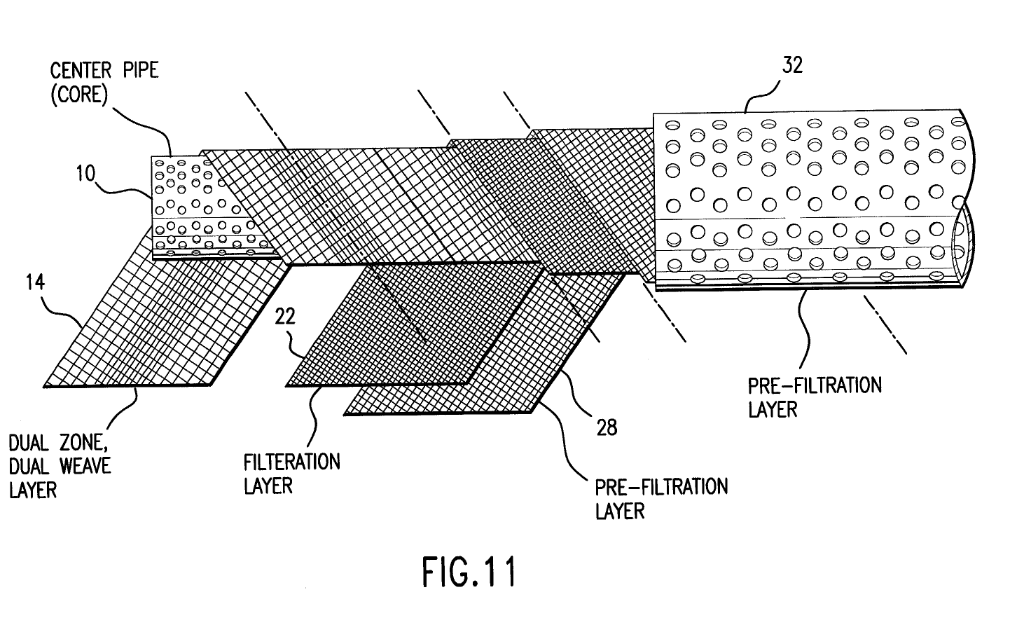

A third metal mesh layer 28, with a micron mesh rating that can be equal to, greater or less than the second metal mesh layer 22, is spirally wound on top of the second metal mesh layer 22. (FIG. 10). The third metal mesh layer edges 31 are aligned to lie on top of the second center midline 30 of the second metal mesh layer 22. This positions the abutting edges of the third metal mesh layer 28 (pre-filtration layer) above the center of the second metal mesh layer 22 (filtration layer).

A perforated metal shroud 32 (perforated pipe) is placed over the metal core 10, and said first, second, and third metal mesh layers 14, 22, and 28 encompassing the entire assembly. (FIG. 11). The perforated metal shroud 32 acts as a protective cover and is in direct contact with the surrounding environment.

The invention will now be described in terms of a specific embodiment.

Embodiment 1—Spiral Style, Butt Seal Along Spiral Seam Incorporating a Dual Micron, Three-Zone Mesh (Fine-Weave and Coarse-Weave Zones) as Drainage Layer

Construction:

Perforated base pipe with any hole pattern followed by a spiral wound layer of dual micron, three-zone mesh, followed by a layer of filtration mesh wrapped on top of the dual micron, three-zone mesh such that the seam formed by the filtration layer is directly over the center of the fine-weave zone of the dual micron, three-zone mesh drainage layer, followed by a layer of pre-filtration mesh on top of the filtration mesh such that the seam formed by the pre-filtration layer is near or directly over the middle of the filtration layer wrap.

In this embodiment, the fine-weave region of the dual-mesh is woven to match the filtration properties of the filtration layer and its position is caused to be being directly below the seam formed by the filtration layer, so as to act as a redundant filtration layer for the seam formed at the filtration layer.

This construction allows the designer to move away from the use of base pipes with perforation patterns designed to avoid the alignment of perforation hole and mesh seam. This construction allows the designer to use butt style seals at the filtration layer seam while significantly reducing the possibility of probability of filtration bypass. This is accomplished by positioning a redundant filtration layer, which is the fine-weave zone of the dual micron mesh, directly below the butt seam of the filtration layer.

This construction does not add any additional wall thickness to the sand control screen.

The specific details of the embodiment are as follows:

base pipe—about 6 inches in diameter, about 20 feet long with perforations

drainage layer—dual micron, three zone (fine-weave and coarse-weave) mesh

overall drainage layer strip length: about 60 feet

width of fine-weave zone: about 1.5 inches, centrally located on the overall drainage layer strip

length of fine-weave zone: same as the overall strip length

micron rating of the fine-weave zone: about 160 micron

mesh count/wire diameter of the fine-weave zone: Reverse Dutch Twill, 160×15.5, 0.0125″/0.0157″

width of the coarse-weave zones: about 2.25 inches, located on each side of the fine-weave zone

length of coarse-weave zones: same as the overall strip length

micron rating of the coarse-weave zones: about 600 micron

mesh count/wire diameter of the coarse-weave zones: Reverse Dutch Twill, 53×15.5, 0.0125″/0.0157″

Filtration layer—uniform micron filtration mesh (standard mesh)

overall filtration layer strip width: about 6 inches

overall filtration layer strip length: about 60 feet

micron rating of the filtration layer: about 160 micron

mesh count/wire diameter of the filtration layer mesh: Reverse Dutch Twill, 160×15.5, 0.0125″/0.0157″

Pre-filtration layer—uniform micron filtration mesh (standard mesh)

overall pre-filtration layer strip width: about 6 inches

overall pre-filtration layer strip length: about 60 feet

micron rating of the pre-filtration layer: about 570 micron

mesh count/wire diameter of the pre-filtration layer: Telamicrodur 545×18, 0.020″/0.024″

See FIG. 11

Another variation envisioned according to the invention would wrap the base pipe having holes with a first mesh layer that is uniform and coarse and functions as the drainage layer. Then the second layer, also of uniform construction, functions as the filtration layer.

The third layer to be applied to the assembly is the specialty mesh, i.e., a dual micron, three zone mesh. The center region of which is the filtration area and is bounded by a coarse lateral region on each side which acts as a pre-filtration layer. The outer sleeve is then positioned over the assembly of mesh layers and core pipe.

In this embodiment, the specialty weave is the last to be wrapped to the base pipe and acts as a pre-filtration layer and a filtration layer above the intermediate filtration layer seam.

In the embodiment last described, the specialty weave is the last layer on the base pipe and acts as a pre-filtration/filtration hybrid.

Although the embodiments listed above are the preferred embodiments, it can be seen through the broad teachings of the inventor that the multi-micron, multi-zone specialty mesh can be used in many different forms to create filtration elements beyond those shown in this patent. Also, the multi-micron, multi-zone mesh can be accomplished not only by varying wire count within the warp family of wires but also by varying the wire diameters used in the warp family of wires. The number, size, location and filtration ratings of the various zones created in a multi-micron, multi-zone mesh are virtually limitless, and have much broader application than those described above. For example, the multi-micron, multi-zoned woven wire mesh of the invention can be used for working sand control screens used in the production of water. The multi-micron, multi-zone mesh can be made in all alloys of metal, in synthetic materials as well as with natural fibers.

What is claimed is:

1. A multi-micron, multi-zoned woven wire mesh cloth comprising: a plurality of parallel warp wires and a plurality of parallel chute wires, said cloth having at least two different and adjacent zones where the number, spacing or wire count of a plurality of warp wires in a first zone is different from the number, spacing or wire count of a plurality of warp wires in a second and adjacent zone.

2. A multi-micron, multi-zoned woven wire mesh cloth comprising: a plurality of parallel warp wires and a plurality of parallel chute wires, said cloth having at least two different and adjacent zones where the diameter of a plurality of warp wires in a first zone is different from the diameter of a plurality of warp wires in a second and adjacent zone.

3. A multi-micron, multi-zoned woven wire mesh cloth comprising: a plurality of parallel warp wires and a plurality of parallel chute wires, said cloth having at least two different and adjacent zones where the spacing number, spacing or wire count between parallel warp wires and the diameter of said warp wires is different from the spacing number, spacing or wire count between parallel warp wires and the diameter of parallel warp wires in a second and adjacent zone.

4. A multi-micron, multi-zoned woven mesh cloth comprising a plurality of parallel warp threads and a plurality of parallel chute threads, where at least some of the threads are metal based or synthetic polymer, said cloth having at least two different and adjacent zones where the parallel warp threads in a first zone are different from the warp threads in an adjacent zone in diameter, spacing, number or wire count.

5. A pipe sand control screen system employing a multi-micron, multi-zoned woven metal mesh, comprising:
a perforated metal core of predetermined length;
a dual micron, three-zone first woven metal mesh layer as a drainage layer spiral wound around said metal core;
wherein said dual micron, three-zone first woven metal mesh layer is a single mesh specialty weave with a fine micron rating in a center region, and more coarse micron rating first and second lateral regions on either side of said center region;
a second woven metal mesh layer, having a predetermined micron rating, as a filtration layer spiral wound on top of said first metal mesh layer;
a third woven metal mesh layer, having a predetermined micron rating, as a pre-filtration layer spiral wound on top of said second metal mesh layer; and
a perforated metal shroud encompassing said metal pipe, and said first, second, and third woven metal mesh layers.

6. The pipe sand control screen system according to claim 5, wherein said second metal mesh layer includes a more coarse mesh micron rating than said center portion of dual micron first metal mesh layer.

7. The pipe sand control screen system according to claim 5, wherein said third metal mesh layer includes a more coarse mesh micron rating than said second metal mesh layer.

8. A pipe sand control screen system employing a multi-micron, multi-zoned woven wire mesh cloth, comprising:
a perforated metal core pipe of predetermined length;
a dual micron three-zone first woven metal wire mesh layer spiral wound around said metal core pipe;
wherein said dual micron, three zone first woven metal wire mesh layer is plurality of parallel wires forming a weave with a fine micron rating in a center region of said layers, and a plurality of parallel wires having a more coarse micron rating and forming a first and second lateral regions on either side of said center region;
a second woven metal wire mesh layer, having a predetermined micron rating, spiral wound on top of said first metal wire mesh layer;
a third woven metal wire mesh layer, having a predetermined micron rating, spiral wound on top of said second metal wire mesh layer; and
a perforated metal shroud encompassing said metal pipe, and said first, second, and third metal wire mesh layers.

9. The pipe sand control screen system according to claim 8, wherein said second metal wire mesh layer includes a more coarse mesh micron rating than said fine region of the said dual micron three-zone first metal wire mesh layer.

10. The pipe sand control screen system according to claim 8, wherein said third metal wire mesh layer includes a more coarse mesh micron rating than said second metal wire mesh layer.

11. A pipe sand control screen system employing a multi-micron, multi-zoned woven metal wire mesh, comprising:
a perforated metal core pipe of predetermined length,
a multi-zone, dual micron first metal wire mesh layer spiral wound around said metal core pipe;
wherein said multi-zone, dual micron first metal wire mesh layer includes a generally center region bounded by a lateral region on each side of said center region, said center region having a weave with a fine micron rating, having a more coarse micron rating than each lateral region on either side of said center region;
a second metal wire mesh layer, having a predetermined micron rating, spiral wound on top of said first metal wire mesh layer;
a third metal wire mesh layer, having a predetermined micron rating, spiral wound on top of said second metal wire mesh layer; and
a perforated metal shroud encompassing said metal core pipe, and said first, second, and third metal wire mesh layers.

12. The pipe sand control screen system according to claim 12, wherein said second metal wire mesh layer includes a more coarse mesh micron rating than said center region of the multi-zone, dual micron first metal wire mesh layer.

13. The pipe sand control screen system according to claim 12, wherein said third metal wire mesh layer includes a more coarse mesh micron rating than said second metal wire mesh layer.

14. A method for producing a multi-micron, multi-zoned mesh for use in a pipe sand control screen system, said method comprising:
providing a metal core pipe of predetermined length with a plurality of holes located on its outer circumference and extending along its length;
spiral wrapping the outer circumference of said metal core pipe with a first metal wire mesh layer includes a plurality of metal wire mesh weaves with predetermined micron ratings distributed in predetermined sections;
spiral wrapping a second layer of metal wire mesh, having at least one section with a predetermined micron rating, located on top of said first layer of metal wire mesh;
spiral wrapping a third layer of metal wire mesh, having at least one section with a predetermined micron rating, located on top of said second layer of metal wire mesh;
abutting edges of said first, second and third layers of metal wire mesh during spiral winding forming a plurality of butt seals; and
encompassing said metal core and said first, second and third metal wire mesh layers in a metal shroud with a plurality of randomly located perforations.

15. The method according to claim 14, the method further comprising overlapping said edges of said first, second and third layers of metal mesh forming a plurality of overlapping seals.

16. A method for producing a multi-micron, multi-zoned mesh for use in a pipe sand control screen system, said method comprising:
providing a metal core of predetermined length, with a plurality of holes located on its outer circumference and extending along its length;
spiral wrapping the outer circumference of said metal core pipe with a first woven metal wire mesh layer, wherein said first woven metal wire mesh layer includes a single layer mesh weave with a fine micron rating in a generally central region, and more coarse micron rating first and second lateral regions on either side of said center region;
spiral wrapping a second layer of metal wire mesh, having a predetermined micron rating, on top of said first metal wire mesh layer;
spiral wrapping a third layer of metal wire mesh, having a predetermined micron rating, on top of said second layer of metal wire mesh;
abutting edges of said first, second and third layers of metal wire mesh during spiral winding forming a plurality of butt seals; and
encompassing said metal pipe and said first, second, and third metal wire mesh layers in a metal shroud with a plurality of randomly located perforations.

17. The method according to claim 14, the method further comprising pre-drilling said holes distributed along said metal pipe.

18. The method according to claim 14, the method further comprising spiral wrapping said second layer of metal wire mesh and aligning second layer lateral edges on top of a first center midline of said first metal wire mesh layer within said center region.

19. The method according to claim 14, the method further comprising spiral wrapping said third layer of metal wire mesh and aligning third layer lateral edges on top of a second center midline of said second metal wire mesh layer.

20. The method according to claim 16, wherein said metal shroud includes a perforated metal pipe.

21. A pipe sand control screen system employing a multi-micron, multi-zoned woven metal mesh, comprising:
a perforated metal core of predetermined length;
a woven metal mesh layer, having a predetermined micron rating, as a drainage layer spiral wound around said metal core;
a dual micron, three-zone first woven metal mesh layer as a filtration layer spiral wound around said metal core;
wherein said dual micron, three-zone first woven metal mesh layer is a single mesh specialty weave with a fine micron rating in a center region, and more coarse micron rating first and second lateral regions on either side of said center region;
a third woven metal mesh layer, having a predetermined micron rating, as a pre-filtration layer spiral wound on top of said second metal mesh layer; and
a perforated metal shroud encompassing said metal pipe, and said first, second, and third woven metal mesh layers.
